(19) United States
(12) Patent Application Publication
(10) Pub. No.: US 2025/0299193 A1
(43) Pub. Date: Sep. 25, 2025

(54) SYSTEMS AND METHODS FOR REAL-TIME FRAUD AND ELECTRONIC TRANSACTION VALUE WEIGHTING

(71) Applicant: Worldpay, LLC, Symmes Township, OH (US)

(72) Inventor: Brendon Paquin, Foxboro, MA (US)

(73) Assignee: Vantiv, LLC, (omitted)

(21) Appl. No.: 15/867,818

(22) Filed: Jan. 11, 2018

(51) Int. Cl. G06Q 20/40

(52) U.S. Cl. CPC G06Q 20/4016

(57) ABSTRACT

Systems and methods are disclosed for processing transactions. One method comprises operating a web server or an application server to generate a graphical user interface for enabling merchants to input inventory information; obtaining transaction information from a merchant over an electronic network; calculating a margin associated with the purchase transaction using the information; using the margin to calculate a first fraud risk value associated with the transaction; comparing the first fraud risk value to a first threshold value; and transmitting a message to the merchant authorizing, declining, or escalating the transaction.

### TECHNICAL FIELD

The present disclosure relates generally to the field of electronic payment transaction analysis and, more particularly, to automated, real-time consideration of transaction value in evaluating and acting on fraud risk.

### BACKGROUND

Numerous parties can face risks associated with fraudulent credit card transactions. For example, issuers, acquirers, and merchants may bear risk in various scenarios. Existing systems may evaluate fraud risk by, e.g., monitoring a cardholder's activities. For example, when a cardholder initiates a transaction such as a purchase with a party such as a merchant, an authorization procedure may evaluate, e.g., an available credit line in order to evaluate whether or not a transaction should be authorized. Certain behavior may also be flagged, which can result in a card being declined due to fraud risk. For example, use of a card for particular types of purchases or in locations distant from a cardholder's home may result in transactions being declined due to a perceived risk of fraud.

Flagging of potentially fraudulent transactions may occur at various points in a transaction. For example, a transaction may be instantly flagged at the time of a purchase at a brick and mortar store at a point of sale (POS) terminal. A transaction may also be declined at the time of purchase in the course of an online transaction through a website, app, or other portal. A transaction may also be subject to further scrutiny in the minutes, hours, or days following a transaction. If a transaction is flagged for potential fraud, the transaction may not be completed. While some customers may pursue the transaction by contacting their credit card issuer or by using alternative payment methods, other customers may forego the transaction altogether.

However, existing automated systems do not consider the various interests a merchant or other party may have in completing a sale. Other parties may include, for example, credit card issuers or processors.

Therefore, a need exists for an automated system which allows for consideration of preferences of merchants or other parties with regard to the subject of a transaction.

### SUMMARY

According to certain aspects of the present disclosure, systems and methods are disclosed for real-time fraud and transaction value weighting.

According to certain aspects of the present disclosure, systems and methods are disclosed for processing transactions.

In one embodiment, a computer-implemented method is disclosed for processing transactions, the method comprising: operating a web server or an application server to generate a graphical user interface for enabling merchants to input inventory information; obtaining transaction information from a merchant over an electronic network; calculating a margin associated with the purchase transaction using the information; using the margin to calculate a first fraud risk value associated with the transaction; comparing the first fraud risk value to a first threshold value; and transmitting a message to the merchant authorizing, declining, or escalating the transaction.

In accordance with another embodiment, a system is disclosed for processing transactions. The system comprises: a memory having processor-readable instructions stored therein; and a processor configured to access the memory and execute the processor-readable instructions, which when executed by the processor configures the processor to perform a plurality of functions, including functions to: operate a web server or an application server to generate a graphical user interface for enabling merchants to input inventory information; obtain transaction information from a merchant over an electronic network; calculate a margin associated with the purchase transaction using the information; use the margin to calculate a first fraud risk value associated with the transaction; compare the first fraud risk value to a first threshold value; and transmit a message to the merchant authorizing, declining, or escalating the transaction.

In accordance with another embodiment, a non-transitory machine-readable medium is disclosed that stores instructions that, when executed by a computer, cause the computer to perform a method for processing transactions. The method includes: operating a web server or an application server to generate a graphical user interface for enabling merchants to input inventory information; obtaining transaction information from a merchant over an electronic network; calculating a margin associated with the purchase transaction using the information; using the margin to calculate a first fraud risk value associated with the transaction; comparing the first fraud risk value to a first threshold value; and transmitting a message to the merchant authorizing, declining, or escalating the transaction.

Additional objects and advantages of the disclosed embodiments will be set forth in part in the description that follows, and in part will be apparent from the description, or may be learned by practice of the disclosed embodiments. The objects and advantages on the disclosed embodiments will be realized and attained by means of the elements and combinations particularly pointed out in the appended claims.

It is to be understood that both the foregoing general description and the following detailed description are exemplary and explanatory only and are not restrictive of the detailed embodiments, as claimed.

It may be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate exemplary embodiments of the present disclosure and together with the description, serve to explain the principles of the disclosure.

FIG. 1 is a schematic diagram showing an exemplary system for processing transactions.

FIG. 2 is a flow chart illustrating an exemplary process for receiving inventory information and providing transaction authorizations.

FIG. 3 is a chart showing exemplary inventory information.

FIG. 4 is a process flow diagram showing an exemplary process for calculating a margin.

FIG. 5 is a process flow diagram showing an exemplary process for processing transactions using margin information.

FIG. 6 is a process flow diagram showing an exemplary process for processing transactions using margin information.

FIG. 7 is a process flow diagram showing an exemplary process for processing transactions using margin information.

FIG. 8 is a process flow diagram showing an exemplary process for processing transactions using margin information.

FIG. 9 is a process flow diagram showing an exemplary process for processing transactions using margin information.

FIG. 10 is a process flow diagram showing an exemplary process for processing transactions using margin information.

### DETAILED DESCRIPTION

While principles of the present disclosure are described herein with reference to illustrative embodiments for particular applications, it should be understood that the disclosure is not limited thereto. Those having ordinary skill in the art and access to the teachings provided herein will recognize additional modifications, applications, embodiments, and substitution of equivalents all fall within the scope of the embodiments described herein. Accordingly, the invention is not to be considered as limited by the foregoing description.

Various non-limiting embodiments of the present disclosure will now be described to provide an overall understanding of the principles of the structure, function, and use of systems and methods disclosed herein for installing and managing point of interaction devices within a merchant environment.

A discussed above, existing systems fail to account for the qualities of a transaction, focusing on the risk profile of a cardholder. Thus, the embodiments of the present disclosure are directed to providing scalable, secure, and efficient mechanisms for evaluating transaction risk and transaction value.

For example, according to one more embodiments of this disclosure, a merchant or other party may provide information regarding inventory, which may include the cost, price, category, and other relevant information regarding items. A merchant or other party may also provide information regarding shipping costs. Such information may be used to calculate, for example, a margin for an item in a transaction, a subset of items in a transaction, or a transaction as a whole. The margin information may be used to evaluate whether a merchant or other party (such as a credit card issuer or processor) desires to proceed with a transaction. For example, margin information may be combined with other fraud indicators in evaluating a transaction. In addition, other information may be used to indicate, for example, items with a high risk of fraud. Thus, information concerning items in a transaction may be used in order to evaluate whether a transaction should be authorized or declined.

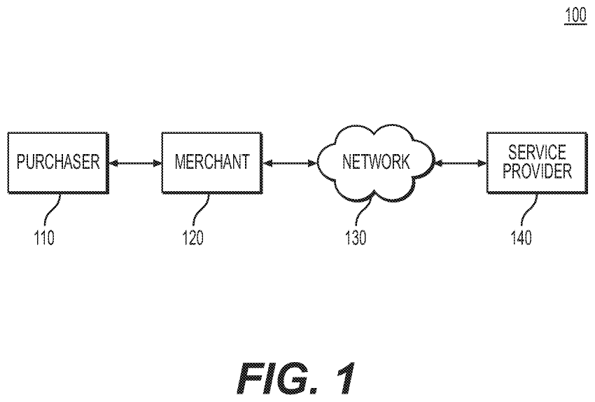

One or more examples of these non-limiting embodiments are illustrated in the selected examples disclosed and described in detail with reference to FIGS. 1-10 in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

While a service provider and a merchant are referred to below, a service provider and a merchant may be the same party and need not be separate entities.

FIG. 1 is a schematic diagram of a distributed computing system 100, including a purchaser 110, a merchant 120, a network 130, and a service provider 140. A purchaser 110 may interact with a merchant 120. For example, a purchaser 110 may initiate a purchase transaction with merchant 120. Purchaser 110 may be an individual or a business entity. Merchant 120 may be a brick and mortar retailer, and purchaser 110 may engage in a transaction in a store using, for example, a point of sale (“POS”) terminal. Merchant 120 may alternatively or additionally be a web-based merchant, and purchaser 110 may engage in a transaction using, for example, a website or an application on a personal computer or on a mobile device. While a merchant may be referred to in describing the figures herein, other parties may also provide the information described or may have the interests described herein. For example, credit card issuers or processors may be substituted for merchants in the disclosed embodiments.

A merchant 120 may interact with a service provider 140 via, for example, a network 130. A service provider 140 may be, for example, an integrator or another type of payment processor. In the alternative, a service provider 140 may be any type of other service that assists with processing transactions such as purchase transactions. Communication between a merchant 120 and a service provider 140 over a network 130 may be performed over a wired or a wireless network. If a merchant 120 is a brick and mortar retailer, then, for example, a POS may communicate with a service provider 140 over a network 130. If a merchant 120 is a web-based merchant, then a merchant's web-based platform may communicate with a service provider 140 over a network 130.

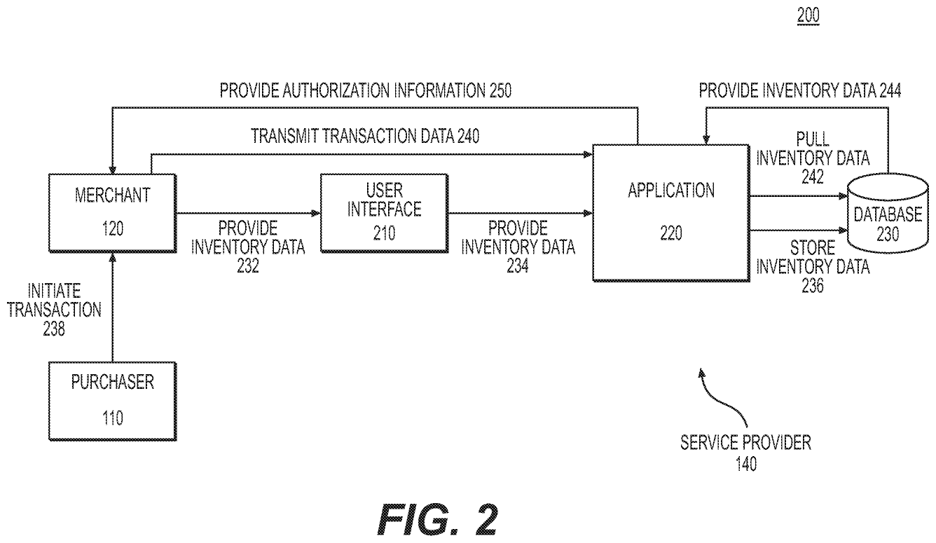

FIG. 2 is a flow chart depicting a process 200 by which a merchant such as merchant 120 as described with regard to FIG. 1 may communicate with a service provider such as service provider 140 as described with regard to FIG. 1.

A merchant 120 may in operation 232 submit data regarding, for example, inventory of a merchant 120. Such inventory information may be submitted using, for example, a user interface (“UI”) 210. UI 210 may be provided by a component of service provider 140. UI 210 may facilitate manual entry of inventory information. For example, data may be entered item by item or data may be entered via, for example, a mass upload. Alternatively, UI 210 may automatically sync with a database containing information about inventory of a merchant 120. UI 210 may be part of a desktop application, mobile application, or web application. Alternatively, service provider 140 may retrieve the data from merchant 120.

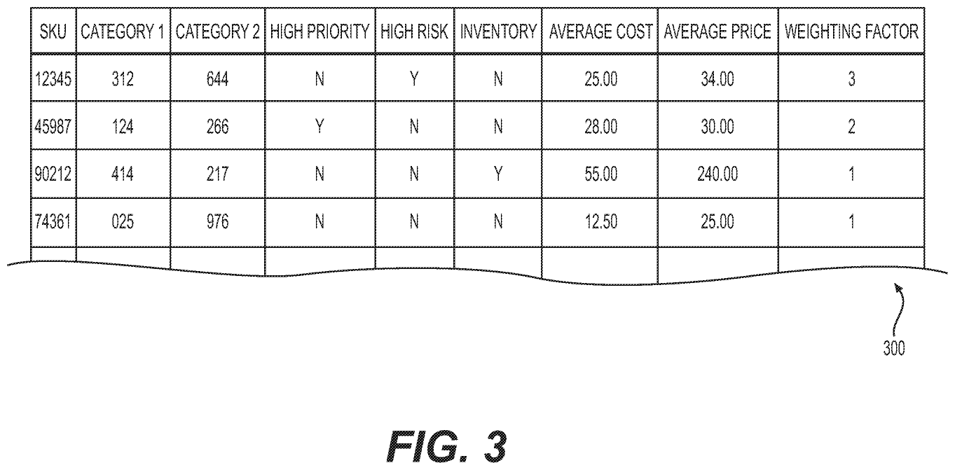

FIG. 3 shows exemplary information that may be provided by a merchant 120 in operation 232. Merchant 120 may provide, for example, information on an item-by-item basis. For example, for a given item, a merchant 120 may provide information regarding a stock keeping unit (“SKU”); an item category; a flag regarding whether, for example, an item is a high priority item or a high risk item; a flag or other indicator of inventory information; an average cost; an average price; and/or a weighting factor. A merchant 120 may also provide additional information or less information, depending on the merchant's needs and preferences.

In the alternative, a merchant 120 may provide data on a merchant level. Such data may include, for example, a merchant's risk preferences, average cost information, and average price information. A merchant 120 may alternatively submit data on, for example, a category level. For example, merchant 120 could submit data for some or each of the categories of merchandise it offers. Categories may be based on, for example, type of good or amount of margin. For example, gift cards or other prepaid instruments may fall into one category and may be subjected to additional scrutiny due to the lack of margin on gift cards. It is contemplated that the types of data described with regard to FIG. 3 could be used in any of the exemplary processes described herein. The data contemplated in FIG. 3 is neither required nor the exclusive data which may be considered. Which data is considered may also vary according to the type of transaction involved (e.g., factors such as customer loyalty, transaction value, fraud data, etc. may determine which data is considered).

A merchant 120 may also submit data regarding shipping information. For example, merchant 120 may submit information regarding shipping, handling or packaging cost formulas. Such information could include average cost to ship to particular locations and may include information about shipment speed. A merchant 120 may also submit information about the weight of an item or a category of items for use in a shipping formula.

Returning to FIG. 2, in operation 234, a user interface 210 may transmit inventory data to an application 220 associated with service provider 140. In the alternative, data from a merchant 120 may be provided directly to application 220 without use of user interface 210. Application 220 may store inventory data in a database 230 in operation 236. Database 230 may be a part of application 220 or may be separate from application 220.

In operation 238, a purchaser 110 may initiate a transaction with merchant 120. Operation 238 may be concurrent or non-concurrent with operation 232, as described above. For example, purchaser 110 may request to purchase one or more items from merchant 120. Operation 238 may be conducted in a brick-and-mortar environment or over the internet, as described above. In operation 240, merchant 120 may transmit transaction data to application 220 or another component of service provider 140. Alternatively, merchant 120 may transmit transaction data to a user interface 210 or to a third party intermediary between merchant 120 and service provider 140.

In operation 242, application 220 may pull inventory data from database 230. The inventory data requested in operation 242 may be data pertaining to items a customer is requesting to purchase. After performing an analysis concerning the purchase request and the inventory data, as discussed in further detail below, application 220 or another component of service provider 140 may provide authorization information to a merchant 120 in operation 250. For example, application 220 may communicate to merchant 120 whether or not a transaction is authorized. Such authorization information as transmitted in operation 250 may be in addition to authorization information transmitted by current systems or in the alternative to the authorization information transmitted by current systems.

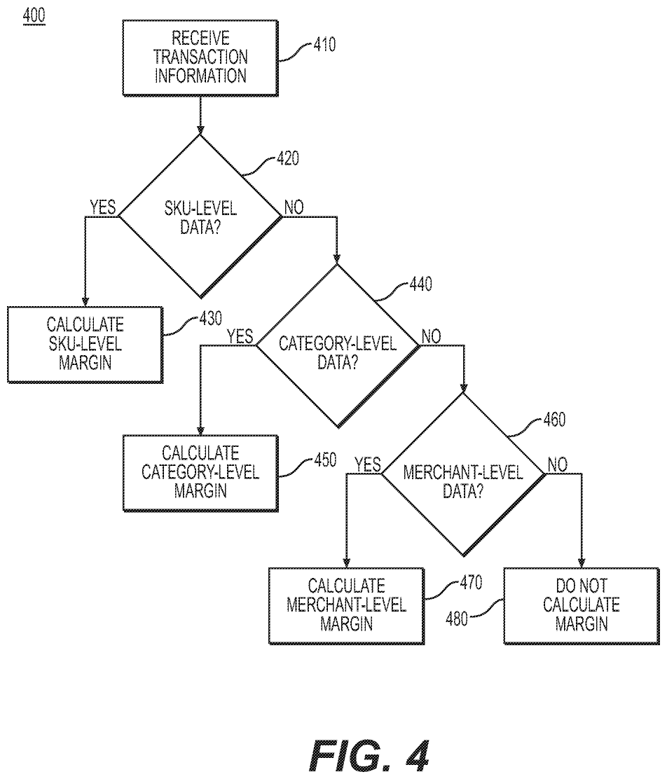

FIG. 4 shows an exemplary process 400 for calculating margins. In this process and in the processes described below, a purchase may, for example, be initiated by a purchaser such as purchaser 110, as described with regard to FIG. 1. The purchase request may be made to a merchant such as merchant 120 as described with regard to FIG. 1. The operations described below with regard to this process and the other processes described herein may be conducted by a component of a service provider such as service provider 140 as depicted in FIG. 1. For example, an application 220 as described with regard to FIG. 2 may perform the operations and steps described with regard to the processes disclosed herein and described below with regard to FIGS. 4-10. The operations described with regard to process 400 and the other processes described herein may be conducted in conjunction with other steps that are not pictured. For example, the results of the processes described herein may be considered along with other factors which may be indicative of fraud, including IP address location, user profile information, credit card limit information, proximity to a cardholder's billing addresses, and/or any other characteristic suggestive of fraud. For example, the processes described herein with regard to FIGS. 4-10 may be performed only in the presence of other fraud indicators, may be performed prior to consideration of other fraud indicators, or may be performed concurrently with consideration of other fraud indicators.

In operation 410, service provider 140 may receive information regarding a transaction. For example, transaction data may be provided as in operation 240 as depicted with regard to FIG. 2. In step 420, service provider 140 may first determine whether SKU-level data exists for one or more of the items in the transaction. If SKU level data exists, in operation 430, service provider 140 may calculate a SKU-level margin for the item(s). In calculating a SKU-level margin as well as the other types of margins described herein, a service provider 140 may subtract a cost from a price. Cost may be an actual cost of the item that is the subject of the purchase request or may be an average cost for that SKU. Price may be an actual price of that item (e.g., as indicated through transaction data) or may be an average price of the SKU. Cost and price data as used throughout this disclosure may be provided by a merchant 120 or another party in advance of a transaction as described, for example, in steps 232, 234, and/or 236 with regard to FIG. 2. In the alternative, cost, price, and other relevant data, such as that described with regard to FIG. 3, may be provided at the time of a particular transaction. Shipping costs of an item may also be accounted for in operation 430 and in the other steps described herein regarding calculating margins. For example, shipping cost may be accounted for as part of the cost of a particular item or group of items. In the alternative, shipping cost may be considered separately. Relevant factors may be an item weight, a shipment origination location, and a shipment destination.

If SKU-level data does not exist, in operation 440, a service provider 140 may determine whether category-level data exists for one or more items in the transaction. If category-level data exists, then in operation 450, service provider 140 may calculate a category-level margin. If category-level data does not exist, then in operation 460, service provider 140 may determine whether merchant-level data exists for one or more items in the transaction. If merchant-level data exists, then in operation 470, a merchant-level margin may be calculated. If merchant-level data does not exist, then a service provider 140 may forego calculating a margin in step 480. Category- and/or merchant-level margins as calculated in operations 450 and 470 may account for the factors described above with regard to operation 430, such as price, cost, and shipping information.

The steps above may be conducted for a transaction as a whole or for subsets of the transaction. For example, a service provider 140 may calculate a SKU-level margin in operation 430 for a subset of items having SKU-level data and a category-level margin in operation 450 for another subset of items having category-level data. In the alternative, a service provider 140 may only calculate a type of margin such as a SKU-level margin or a category-level margin if that type of data exists for all of the items in a transaction. In the alternative, a service provider 140 may calculate a type of margin such as a SKU-level margin or a category-level margin if that type of data exists for an amount of items in a transaction above a certain threshold (e.g., a threshold based on proportion of cost, price, or number of items). Different types of margins may also be calculated for a given item. For example, a SKU-level margin, a category-level margin, and a merchant-level margin could be considered with regard to one or more items in a transaction.

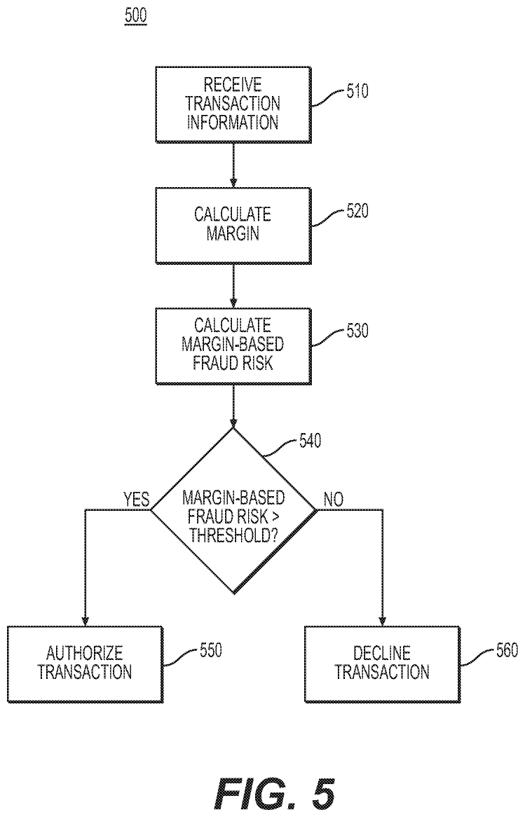

FIG. 5 depicts an exemplary process for analyzing a transaction. In operation 510, service provider 140 may receive information regarding a transaction. For example, transaction data may be provided as in operation 240 as depicted with regard to FIG. 2. In operation 520, a service provider 140 may calculate a margin. For example, service provider 140 may calculate a margin according to one or more of the processes described with regard to FIG. 4. The margin calculated in operation 520 may include one type of margin (e.g., a SKU-level margin, a category-level margin, or a merchant-level margin) or may include more than one type of margin. In operation 520, different types of margins may also be reconciled into one margin value or may be maintained as separate margin values.

In operation 530, a service provider 540 may calculate a margin-based fraud risk. A margin-based fraud risk calculated in operation 530 may account for any type of fraud risk calculated by existing systems. In addition, a margin-based fraud risk calculated in operation 530 may account for a margin calculated in operation 520. A margin calculated in operation 520 may modulate a merchant's 120 tolerance for fraud risk. For example, a low or relatively low margin on items in a transaction may lower a fraud risk for merchant 120. If a merchant 120 does not expect to receive a large profit from a particular transaction, merchant 120 may prefer not to engage in a transaction. A low margin calculated in operation 520 may independently result in low margin-based fraud risk calculated in operation 530. Alternatively, a low margin calculated in operation 620 may result in a high margin-based fraud risk only if other fraud risk indicators are present. On the other hand, a high margin calculated in operation 520 may increase a merchant's tolerance for fraud risk, resulting in a high margin-based fraud risk.

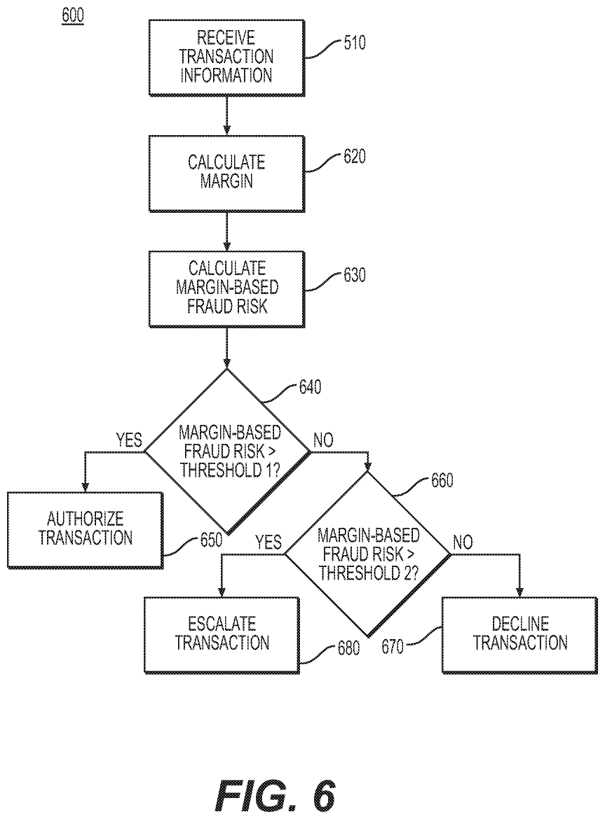

A margin-based fraud risk, as calculated in operation 530 and other operations described herein for calculating margin-based fraud risks (e.g., with regard to FIGS. 6-10, to be described below), may account for shipping costs if shipping costs have not been accounted for in a margin calculation. For example, operation 530 may consider factors such as item weight, shipping origination location, and shipping destination. Other factors may also be considered. For example, international shipments may contribute to a higher margin-based fraud risk. Local shipments may contribute to a lower margin-based fraud risk.

In operation 540, a margin-based fraud risk calculated in step 530 may be compared to a threshold value. A threshold value used in operation 540 may vary depending on the preferences of a merchant 120 or may be the same across different merchants. A threshold value may be constant for a particular merchant 120 or may vary over time, with class of purchaser 110, with categories of merchandise, or according to other factors. The same is true with regard to the other thresholds described herein. If a margin-based fraud risk exceeds the threshold value, then the transaction may be authorized in operation 550. If the margin-based fraud risk does not exceed the threshold value, then the transaction may be declined in operation 560.

FIG. 6 depicts a further exemplary process for analyzing a transaction. As described with regard to FIG. 5, a service provider 140 may receive transaction information in step 510. In step 620, service provider 140 may calculate a margin. The margin calculated may be calculated by methods that are the same as or similar to the methods described with regard to step 520. In step 630, a margin-based fraud risk may be calculated. The margin-based fraud risk may be calculated by methods that are the same as or similar to the methods described with regard to step 530.

In step 640, the margin-based fraud risk may be compared to a first threshold value. A first threshold value considered in step 640 may be set in a manner similar to or the same as the threshold value considered in step 540. In the alternative, the first threshold value considered in step 640 may be different than the threshold value considered in step 540. For example, the first threshold value considered in step 640 may be higher than the threshold value considered in step 540. If the margin-based fraud risk calculated in step 630 exceeds the first threshold in step 640, then the transaction may be authorized in step 650.

If the margin-based fraud risk calculated in step 630 does not exceed the first threshold in step 640, then the margin-based fraud risk may be compared to a second threshold value in step 660. As compared to the first threshold value considered in step 640, the second threshold value considered in step 660 may be lower. If the margin-based fraud risk calculated in step 630 exceeds the second threshold value in step 660, then the transaction may be escalated or otherwise further processed in step 680. For example, in step 680, a transaction may be forwarded to separate system or to personnel who analyze transactions. It is contemplated that the escalation described in step 680 also occur after any comparisons of margin-based fraud risks to thresholds as described above or below. For example, rather than decline or authorize a transaction outright, a transaction may be elevated in any of the processes described in this disclosure. A transaction with a margin-based fraud risk exceeding the second threshold value considered in operation 660 may be one that need not be declined outright but may require further analysis before authorization because the margin-based fraud risk does not exceed the threshold value considered in operation 640. If the margin-based fraud risk calculated in step 630 does not exceed the second threshold considered in step 660, then the transaction may be declined in step 670.

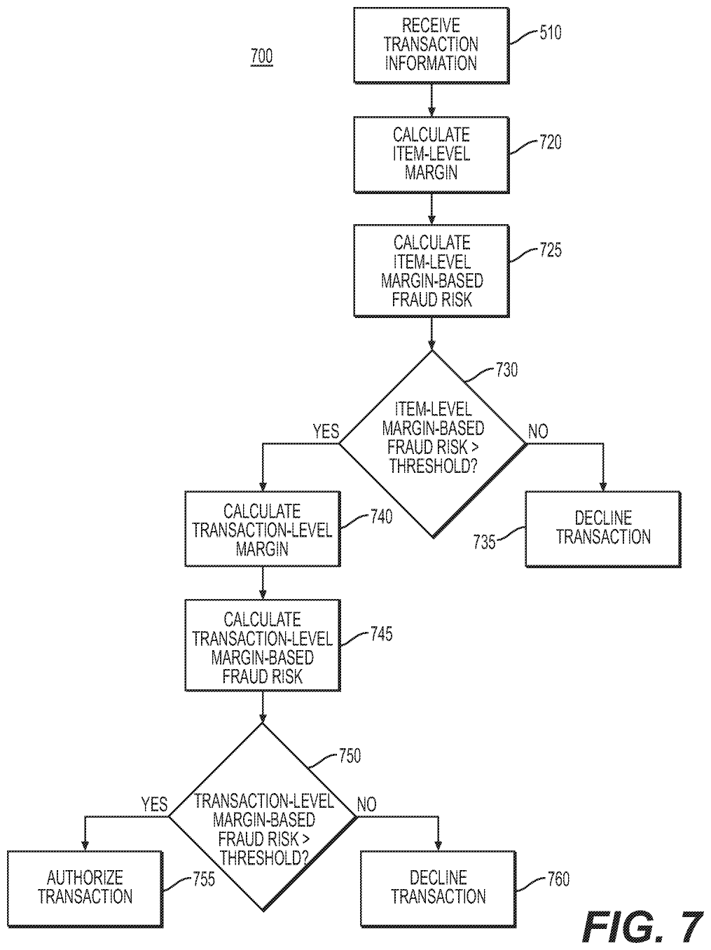

FIG. 7 depicts a further exemplary process for analyzing a transaction. As described with regard to FIG. 5, a service provider 140 may receive transaction information in step 510. In step 720, an item-level margin may be calculated. An item-level margin may be calculated, for example, according to the processes described with regard to FIG. 4. An item-level margin may be based on, for example, SKU-level data, or category-level data. Step 720 may be performed for some or all items in a transaction. For example, step 720 may result in different item-level margin values for each of the items in a transaction. In step 725, an item-level margin-based fraud risk may be calculated using the item-level margin calculated in step 720. An item-level margin-based fraud risk may be calculated in step 725 for some or all of the items in a transaction. The item-level margin-based fraud risk may be calculated in a manner similar to that used in step 530, as described with regard to FIG. 5. In step 730, the item-level margin-based fraud risk calculated in step 725 may be compared to a threshold value. A threshold value used in step 730 may be the same as or similar to the threshold value considered in step 540, as described with regard to FIG. 5, and/or the threshold values considered in steps 640 and 660, as described with regard to FIG. 6. Alternatively, step 730 may consider a different threshold value. Step 730 may be repeated for some or all of the items in a transaction.

If the margin-based fraud risk does not exceed the threshold in step 730, then the transaction may be declined in step 735. A transaction may be declined in step 735 if the item-level margin-based fraud risk for any item in a transaction fails to exceed the threshold considered in step 730. Alternatively, a transaction may be declined in step 735 only if the item-level margin-based fraud risk fails to exceed the threshold considered in step 730 for all items in a transaction. In a still further alternative, a transaction may be declined in step 735 if a certain subset of items in a transaction fail to have a margin-based fraud risk exceeding the threshold considered in step 730. For example, a transaction may be declined in step 735 if a certain proportion of a transaction by number of items or value of items fails to have a margin-based fraud risk exceeding the threshold considered in step 730. Factors such as weighting factors may also be considered. For example, certain items may be considered as contributing more or less to a margin-based fraud risk depending on their value, their importance to customer loyalty, their fraud risk, or any other relevant factor. Alternatively, a transaction may be declined in step 735 if a certain raw number of items or raw value of items fail to have a margin-based fraud risk exceeding the threshold considered in step 730.

If the item-level margin-based fraud risk exceeds the threshold, then a transaction-level margin may be calculated in step 740. A transaction-level margin calculated in step 740 may consider the price and cost of a transaction as a whole. The price considered may be the actual price for some or all of the items in a transaction or the average price for some or all of the items in a transaction. The cost considered may be the actual cost for some or all of the items in a transaction or the average cost for some or all of the items in a transaction. In step 745, a transaction-level margin-based fraud risk may be calculated. The transaction-level margin-based fraud risk may be calculated in a manner that is the same as or similar to step 530, as described with regard to FIG. 5.

In step 750, the transaction-level margin-based fraud risk may be compared to a threshold value. The threshold value considered in step 750 may be the same as the threshold value considered in step 730. Alternatively, the threshold value considered in step 750 may be different from the threshold value considered in step 730. For example, the threshold value considered in step 750 may be lower than the threshold value considered in step 730. If the transaction-level margin-based fraud risk is exceeds the threshold in step 750, then the transaction may be authorized. If the transaction-level margin-based fraud risk does not exceed the threshold in step 750, then the transaction may be declined. It may be desirable to consider both an item-level margin based fraud risk and a transaction-level margin-based fraud risk because, while the margins on individual items may not modulate a fraud tolerance of merchant 120, the margin on a transaction as a whole may modulate the fraud tolerance of merchant 120.

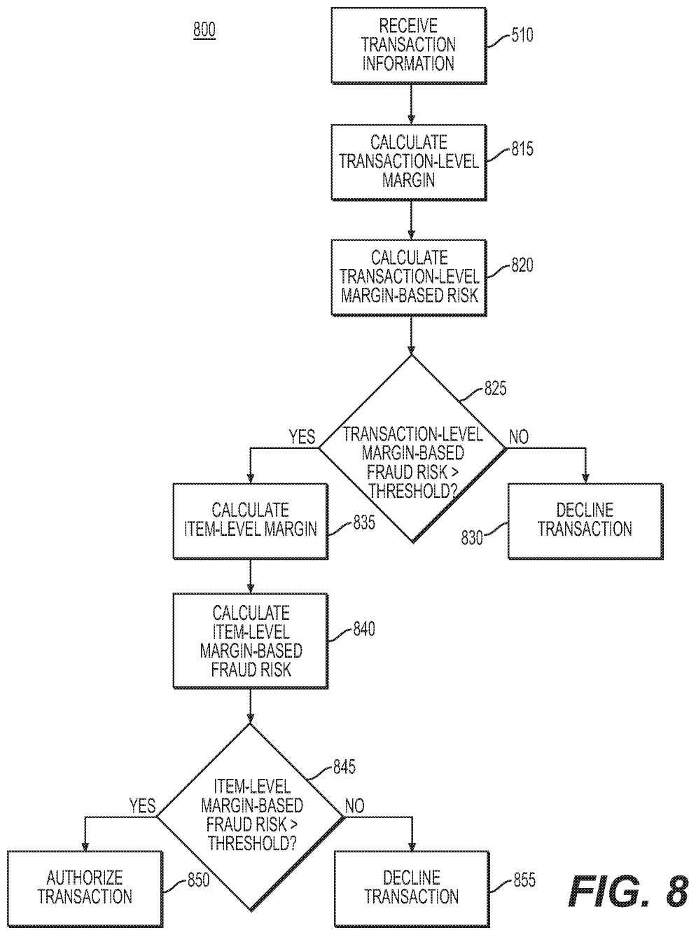

It is contemplated that the steps described with regard to FIG. 7 could be performed in a different order. For example, the transaction-level margin-based fraud risk could be considered before the item-level margin-based fraud risk. Such a process is shown in FIG. 8. In step 510, a service provider 140 may receive transaction information, as described with regard to FIG. 5. In step 815, a transaction-level margin may be calculated. Such a margin may be calculated in a manner that is the same as or similar to the calculation in step 740, as described with regard to FIG. 7. In step 820, a transaction-level margin-based fraud risk may be calculated. Step 820 may be the same as or similar to step 745, as described with regard to FIG. 7. In step 825, a transaction-level margin-based fraud risk may be compared to a threshold value. Step 825 may be the same as or similar to step 750, as described with regard to FIG. 7. In step 830, a transaction may be declined if the transaction-level margin-based fraud risk does not exceed the threshold. Step 830 may be the same as or similar to step 760 as described with regard to FIG. 7.

If the transaction-level margin-based fraud risk exceeds the threshold in step 825, then an item-level margin may be calculated in step 835. Step 835 may be the same as or similar to step 720, as described with regard to FIG. 7. In step 840, an item-level margin-based fraud risk may be calculated. Step 840 may be the same as or similar to step 725, as described with regard to FIG. 7. In step 845, the item-level margin-based fraud risk may be compared to a threshold value. Step 845 may be the same as or similar to step 730 as described with regard to FIG. 7. If the item-level margin-based fraud risk exceeds the threshold value considered in step 845, then the transaction may be authorized in step 850. If the item-level margin-based fraud risk does not exceed the threshold value considered in step 845, then the transaction may be declined. In the alternative, a transaction may be elevated for further consideration depending on the outcome of process 800. For example, certain margin-based fraud risk as calculated in either step 820 or 840 may result in a transaction being escalated.

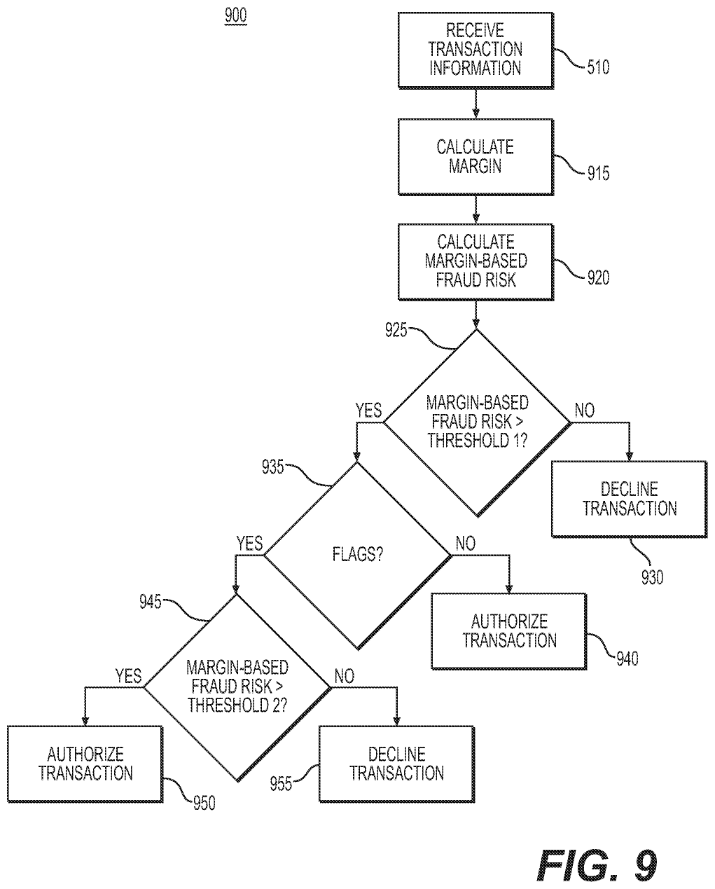

FIG. 9 depicts an exemplary process 900 for analyzing a transaction in the presence of, for example, flagged information. As described with regard to FIG. 5, a service provider 140 may receive transaction information in step 510. In step 915, a service provider 140 may calculate a margin. The margin calculated in step 915 may be one or more of the types of margins contemplated in this disclosure. For example, a margin calculated in step 915 may be a margin calculated according to the process described in FIG. 4 or for any of the other figures described herein. In step 920, a margin-based fraud risk may be calculated. The margin-based fraud risk may be calculated according to any process described herein, for example according to the processes described with regard to FIGS. 5-8. In step 925, the margin-based fraud risk may be compared to a first threshold value. Step 925 may be the same as or similar to, for example, any of the margin-based fraud risk and threshold comparisons described with regard to FIGS. 5-8. If the margin-based fraud risk does not exceed the first threshold, the transaction may be declined in operation 930.

If the margin-based fraud risk exceeds the first threshold, service provider 140 may check for any flags involved with an item or transaction in step 935. For example, a flag may be put in place for one or more items that have a high fraud risk, as described with regard to FIG. 3. For example, one or items may be flagged because of historical fraud behavior with regard to those items or because of a low margin with regard to those items. Other factors such as inventory may also be considered. For example, if a merchant has low inventory or rapidly decreasing inventory of a desirable item, the merchant may desire extra scrutiny be placed on transactions regarding that item. The inquiry of step 935 may involve ascertaining whether at least one item has a relevant flag. In the alternative, the inquiry of step 935 may involve checking to see whether a certain proportion (e.g., by number of items or by transaction value) of a transaction has flags. A weighting factor may also be considered-that is, the presence or absence of flags on certain items may carry more weight than the presence or absence of flags on other items. If no flags are present, a transaction may be authorized in step 940.

If flags are present, further processing may occur. For example, the margin-based fraud risk may be compared to a second threshold in step 945. The margin-based fraud risk used in step 945 may be the same as the margin-based fraud risk calculated in step 920. In the alternative, the margin-based fraud risk may be recalculated based on the presence and/or absence of, for example, flags. For example, the margin-based fraud risk used in step 945 may apply different weighting factors or may assign greater consideration to flagged items. The second threshold may be the same as the threshold of step 925 or may be a different threshold. For example, the threshold may be higher in step 945 than in step 925. A higher threshold may take into account the presence of flags on one or more items in a transaction. If the margin-based fraud risk exceeds the second threshold, then the transaction may be authorized in step 950. If the margin-based fraud risk does not exceed the second threshold, then the transaction may be declined in step 955. In the alternative, following step 935, a transaction may be declined if flags are present or may be escalated for further processing by other systems if flags are present.

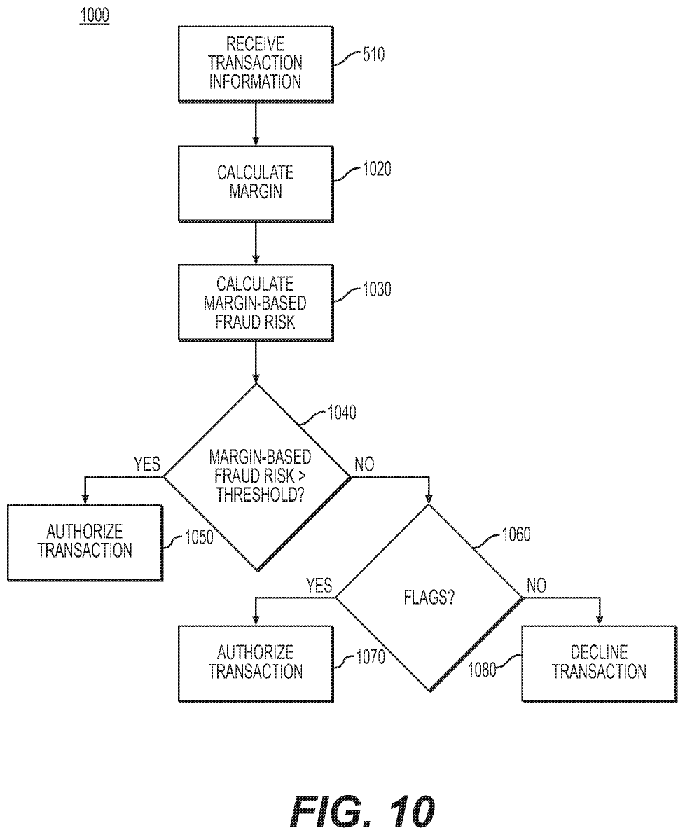

FIG. 10 depicts a further exemplary process 1000 for analyzing a transaction in the presence of, for example, flagged information. As described with regard to FIG. 5, a service provider 140 may receive transaction information in step 510. In step 1020, a service provider 140 may calculate a margin. The margin calculated in step 1020 may be one or more of the types of margins contemplated in this disclosure. For example, a margin calculated in step 1020 may be a margin calculated according to the process described in FIG. 4 or for any of the other figures described herein. In step 1030, a margin-based fraud risk may be calculated. The margin-based fraud risk may be calculated according to any process described herein, for example according to the processes described with regard to FIGS. 5-9. In step 1040, the margin-based fraud risk may be compared to a first threshold value. Step 1040 may be the same as or similar to, for example, any of the margin-based fraud risk and threshold comparisons described with regard to FIGS. 5-9. If the margin-based fraud risk exceeds the first threshold, then the transaction may be approved in step 1050.

If the margin-based fraud risk does the first threshold, service provider 140 may check for any flags involved with an item or transaction in step 1060. For example, a flag may be put in place for one or more items that have a high loyalty value or items that a merchant would like to sell a greater volume of, as described with regard to FIG.

3. Other factors such as inventory may also be considered. For example, if a merchant has a high inventory of an item, the merchant may desire less scrutiny be placed on transactions regarding that item. The inquiry of step 1060 may involve ascertaining whether at least one item has a relevant flag. In the alternative, the inquiry of step 1060 may involve checking to see whether a certain proportion (e.g., by number of items or by transaction value) of a transaction has flags. A weighting factor may also be considered—that is, the presence or absence of flags on certain items may carry more weight than the presence or absence of flags on other items. If no flags are present, a transaction may be declined in operation 1080. If flags are present, a transaction may be authorized in operation 1070. In the alternative, if flags are present, further processing may occur. Such processing may be the same as or similar to steps 945, 950, and/or 955 as depicted with regard to FIG. 9. If a second threshold value is considered, the second threshold value may be lower than the threshold value considered in step 1040.

If flags are present, further processing may occur. For example, the margin-based fraud risk may be compared to a second threshold in step 945. The margin-based fraud risk used in step 945 may be the same as the margin-based fraud risk calculated in step 920. In the alternative, the margin-based fraud risk may be recalculated based on the presence and/or absence of, for example, flags. For example, the margin-based fraud risk used in step 945 may apply different weighting factors or may assign greater consideration to flagged items. The second threshold may be the same as the threshold of step 925 or may be a different threshold. For example, the threshold may be higher in step 945 than in step 925. A higher threshold may take into account the presence of flags on one or more items in a transaction. If the margin-based fraud risk exceeds the second threshold, then the transaction may be authorized in step 950. If the margin-based fraud risk does not exceed the second threshold, then the transaction may be declined in step 955.

These and other embodiments of the systems and methods may be used as would be recognized by those skilled in the art. The above descriptions of various systems and methods are intended to illustrate specific examples and describe certain ways of making and using the systems disclosed and described here. These descriptions are neither intended to be nor should be taken as an exhaustive list of the possible ways in which these systems can be made and used. A number of modifications, including substitutions of systems between or among examples and variations among combinations can be made. Those modifications and variations should be apparent to those of ordinary skill in this area after having read this disclosure.

The systems, apparatuses, devices, and methods disclosed herein are described in detail by way of examples and with reference to the figures. The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures or characteristics may be combined in any suitable manner in one or more embodiments.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context. It should be noted that although for clarity and to aid in understanding some examples discussed herein might describe specific features or functions as part of a specific component or module, or as occurring at a specific layer of a computing device (for example, a hardware layer, operating system layer, or application layer), those features or functions may be implemented as part of a different component or module or operated at a different layer of a communication protocol stack. Those of ordinary skill in the art will recognize that the systems, apparatuses, devices, and methods described herein can be applied to, or easily modified for use with, other types of equipment, can use other arrangements of computing systems such as client-server distributed systems, and can use other protocols, or operate at other layers in communication protocol stacks, than are described.

It is intended that the specification and examples be considered as exemplary only, with a true scope and spirit of the invention being indicated by the following claims.

1. A computer-implemented method of processing a transaction using a computing system of a service provider, the method comprising:
generating, by a web server of the service provider, one or more interactive user interface elements in a graphical user interface;
transmitting, by a processor of the computing system of the service provider, the graphical user interface to a user device associated with a merchant system;
receiving, by the processor of the computing system of the service provider, one or more user interactions with the one or more interactive user interface elements from the user device, wherein the one or more user interactions includes input inventory information of the merchant system;
writing, by the processor of the computing system of the service provider, the input inventory information to a database associated with the computing system of the service provider, wherein the input inventory information written to the database includes data items associated with at least one item, the data items including an identifier of the at least one item, a category of the at least one item, an average cost of the at least one item, and average price of the at least one item, one or more of a high priority indicator and a high fraud risk indicator associated with the at least one item, and a weighting factor of the at least one item;
receiving, by the processor of the computing system of the service provider, transaction information associated with the transaction occurring at a point of sale (POS) terminal associated with the merchant system;
determining, by the processor of the computing system of the service provider, that the transaction information includes the identifier of the at least one item;
selecting, by the processor of the computing system of the service provider, a unique set of one or more of the data items associated with the at least one item according to the transaction information associated with the transaction occurring at the POS terminal:
determining, by the processor of the computing system of the service provider, a margin value for the at least one item using the unique set of the one or more of the data items associated with the at least one item;
determining, by the processor of the computing system of the service provider, a first fraud risk value associated with the transaction based on the margin value;
determining, by the processor of the computing system of the service provider and in real time as the transaction is occurring at the POS terminal, that the first fraud risk value does not exceed a first threshold value;
determining, by the processor of the computing system of the service provider and in real time as the transaction is occurring at the POS terminal, that the first fraud risk value exceeds a second threshold value, wherein the second threshold value is lower than the first threshold value; and
analyzing, by the processor of the computing system of the service provider, the transaction information, wherein the transaction occurring at the POS terminal is neither authorized nor declined based on determining that the first fraud risk value exceeds the second threshold value.

2. (canceled)

3. The method of claim 1, wherein the at least one item is associated with merchant-provided data, and wherein at least one of a price, cost, shipping information, or a fraud risk flag is associated with the merchant-provided data.

4. The method of claim 1, wherein the input inventory information includes merchant-provided category data, and wherein at least one of a price, cost, shipping information, or a fraud risk flag is associated with the merchant-provided category data.

5. (canceled)

6. (canceled)

7. The method of claim 1, wherein determining the margin value includes a calculation of shipping costs.

8. (canceled)

9. (canceled)

10. (canceled)

11. The method of claim 1, further comprising:
determining, by the processor of the computing system of the service provider, a second fraud risk value associated with the transaction based on at least one of stock unit level data or category-level data; and
comparing, by the processor of the computing system of the service provider, the second fraud risk value to a third threshold value.

12. The method of claim 11, wherein the first fraud risk value is equal to the second fraud risk value.

13. (canceled)

14. The method of claim 1, wherein an authorization response message is transmitted in real time as the transaction is occurring at the POS terminal based on determining that the first fraud risk value does not exceed the second threshold value.

15. A computer system for processing a transaction, the system comprising:
a web server;
a memory having processor-readable instructions stored therein; and
a processor that accesses the memory and performs, via the web server, operations comprising:
generating, by the web server of a service provider, one or more interactive user interface elements in a graphical user interface;
transmitting, by the processor, the graphical user interface to a user device associated with a merchant system;
receiving, by the processor, one or more user interactions with the one or more interactive user interface elements from the user device, wherein the one or more user interactions includes input inventory information of the merchant system;
writing, by the processor, the input inventory information to a database associated with the computer system of the service provider, wherein the input inventory information written to the database includes data items associated with at least one item, the data items including an identifier of the at least one item, a category of the at least one item, an average cost of the at least one item, and average price of the at least one item, one or more of a high priority indicator and a high fraud risk indicator associated with the at least one item, and a weighting factor of the at least one item;
receiving, by the processor, transaction information associated with the transaction occurring at a point of sale (POS) terminal associated with the merchant system;
determining, by the processor, that the transaction information includes the identifier of the at least one item;
selecting, by the processor, a unique set of one or more of the data items associated with the at least one item according to the transaction information associated with the transaction occurring at the POS terminal;
determining, by the processor, a margin value for the at least one item using the unique set of the one or more of the data items associated with the at least one item;
determining, by the processor, a first fraud risk value associated with the transaction based on the margin value;
determining, by the processor and in real time as the transaction is occurring at the POS terminal, that the first fraud risk value does not exceed a first threshold value;
determining, by the processor and in real time as the transaction is occurring at the POS terminal, that the first fraud risk value exceeds a second threshold value, wherein the second threshold value is lower than the first threshold value; and
analyzing, by the processor, the transaction information, wherein the transaction occurring at the POS terminal is neither authorized nor declined based on determining that the first fraud risk value exceeds the second threshold value.

16. The computer system of claim 15, wherein the operations further comprise:
determining, by the processor, a second fraud risk value associated with the transaction based on at least one of stock unit level data or category-level data; and
comparing, by the processor, the second fraud risk value to a third threshold value.

17. The computer system of claim 16, wherein the first fraud risk value is equal to the second fraud risk value.

18. A non-transitory computer readable medium storing a program that controls a web server to execute a method of processing a transaction, the method comprising:
generating, by the web server of a service provider, one or more interactive user interface elements in a graphical user interface;
transmitting, by a processor of a computing system of the service provider, the graphical user interface to a user device associated with a merchant system;
receiving, by the processor of the computing system of the service provider, one or more user interactions with the one or more interactive user interface elements from the user device, wherein the one or more user interactions includes input inventory information of the merchant system;
writing, by the processor of the computing system of the service provider, the input inventory information to a database associated with the computing system of the service provider, wherein the input inventory information written to the database includes data items associated with at least one item, the data items including an identifier of the at least one item, a category of the at least one item, an average cost of the at least one item, and average price of the at least one item, one or more of a high priority indicator and a high fraud risk indicator associated with the at least one item, and a weighting factor of the at least one item;
receiving, by the processor of the computing system of the service provider, transaction information associated with the transaction occurring at a point of sale (POS) terminal associated with the merchant system;
determining, by the processor of the computing system of the service provider, that the transaction information includes the identifier of the at least one item;
selecting, by the processor of the computing system of the service provider, a unique set of one or more of the data items associated with the at least one item according to the transaction information associated with the transaction occurring at the POS terminal;
determining, by the processor of the computing system of the service provider, a margin value for the at least one item using the unique set of the one or more of the data items associated with the at least one item;
determining, by the processor of the computing system of the service provider, a first fraud risk value associated with the transaction based on the margin value;
determining, by the processor of the computing system of the service provider and in real time as the transaction is occurring at the POS terminal, that the first fraud risk value does not exceed a first threshold value;
determining, by the processor of the computing system of the service provider and in real time as the transaction is occurring at the POS terminal, that the first fraud risk value exceeds a second threshold value, wherein the second threshold value is lower than the first threshold value; and
analyzing, by the processor of the computing system of the service provider, the transaction information, wherein the transaction occurring at the POS terminal is neither authorized nor declined based on determining that the first fraud risk value exceeds the second threshold value.

19. The non-transitory computer readable medium of claim 18, wherein the method further comprises:
determining, by the processor of the computing system of the service provider, a second fraud risk value associated with the transaction based on at least one of stock unit level data or category-level data; and
comparing, by the processor of the computing system of the service provider, the second fraud risk value to a third threshold value.

20. The non-transitory computer readable medium of claim 19, wherein the first fraud risk value is equal to the second fraud risk value.

21. The method of claim 1, further comprising:
determining, by the processor of the computing system of the service provider, that merchant-level data associated with the transaction information exists in the input inventory information; and
determining, by the processor of the computing system of the service provider, a third margin value associated with the merchant-level data.

22. The method of claim 1, wherein an authorization response message including a decline message is transmitted based on the analyzing and based on the first fraud risk value not exceeding the first threshold value.

23. (canceled)

24. The method of claim 1, further comprising:
determining, by the processor of the computing system of the service provider, that the first fraud risk value exceeds the first threshold value;
determining, by the processor of the computing system of the service provider, that one or more flags are associated with the transaction;
comparing, by the processor of the computing system of the service provider, the first fraud risk value to the second threshold value; and
authorizing, by the processor of the computing system of the service provider, the transaction upon determining the first fraud risk value exceeds the second threshold value.

25. The method of claim 1, further comprising:
determining, by the processor of the computing system of the service provider, that one or more flags are associated with the transaction;
applying, by the processor of the computing system of the service provider, a weighting factor to the one or more flags; and
recalculating, by the processor of the computing system of the service provider, the first fraud risk value based on the one or more flags.

26. The method of claim 1, further comprising:
calculating, by the processor of the computing system of the service provider, an item-level margin associated with the transaction information, wherein the item-level margin is calculated for the at least one item in the transaction;
calculating, by the processor of the computing system of the service provider, a second fraud risk value based on the item-level margin;
comparing, by the processor of the computing system of the service provider, the second fraud risk value to the second threshold value, wherein a transaction-level margin is calculated upon determining the calculated second fraud risk value exceeds the second threshold value;
calculating, by the processor of the computing system of the service provider, a third fraud risk value based on the transaction-level margin; and
comparing, by the processor of the computing system of the service provider, the third fraud risk value to a third threshold value, wherein the transaction is authorized upon determining the third fraud risk value exceeds the third threshold value.
